(19) United States
(12) Patent Application Publication
(10) Pub. No.: US 2024/0152353 A1
(43) Pub. Date: May 9, 2024

(54) VEHICLE-MOUNTED DEVICE AND PROGRAM UPDATING SYSTEM

(71) Applicant: HITACHI ASTEMO, LTD., Hitachinaka-shi, Ibaraki (JP)

(72) Inventors: Wataru IBA, Chiyoda-ku, Tokyo (JP); Shuhei KANEKO, Chiyoda-ku, Tokyo (JP); Mikio KATAOKA, Chiyoda-ku, Tokyo (JP)

(73) Assignee: HITACHI ASTEMO, LTD., Hitachinaka-shi, Ibaraki (JP)

(21) Appl. No.: 18/548,985

(22) PCT Filed: Mar. 1, 2022
(86) PCT No.: PCT/JP2022/008677

§ 371 Date: Sep. 5, 2023

(30) Foreign Application Priority Data
Sep. 17, 2021 (JP) 2021-152514

(51) Int. Cl. G06F 8/65

(52) U.S. Cl. CPC G06F 8/65; B60R 16/02

(57) ABSTRACT

An object of the present invention is to minimize a likelihood of the vehicle becoming in an inoperable state even in an event of a program update failure. An in-vehicle device 6 includes: a program storage unit 64 that stores a program; an activation processing unit 65 that activates the program; and an update processing unit 63 that receives an update program 21 and an update reason 22 of the program and updates the program with the update program 21. In a case where the update of the program has failed, the activation processing unit 65 activates the program in an activation mode corresponding to the update reason 22.

### TECHNICAL FIELD

The present invention relates to an in-vehicle device on which a program is implemented and a program update system that updates the program.

### BACKGROUND ART

In an in-vehicle device, on which a program is implemented, such as an electronic control unit (ECU) that controls a vehicle or a gateway ECU, it is known that the program is updated by over the air (OTA) or the like. In this type of in-vehicle device, when an event such as interruption of energization to the in-vehicle device (hereinafter also referred to as “power supply interruption”) occurs during update of the program, the update of the program may fail. In this case, the in-vehicle device generally activates the program in a degeneration mode of performing only the update of the program, and in the worst case, the vehicle cannot normally operate (hereinafter, also referred to as “inoperable state”). PTL 1 discloses a technique in which a simple program is activated to perform vehicle evacuation travel even in a case where the update of the program is not normally performed.

### CITATION LIST

### Patent Literature

PTL 1: JP 2010-125925 A

### SUMMARY OF INVENTION

### Technical Problem

In the technique disclosed in PTL 1, it is expected that in an event of a program update failure, the simple program is activated to perform the vehicle evacuation travel, so as to reduce a likelihood of the vehicle becoming in the inoperable state. However, in the technique disclosed in PTL 1, in a case where there is a functional defect or the like in the simple program, there is a possibility that the vehicle becomes in the inoperable state, and there is room for improvement.

The present invention has been made in view of the above, and an object of the present invention is to minimize a likelihood of the vehicle becoming in an inoperable state even in an event of a program update failure.

### Solution to Problem

In order to solve the above problem, an in-vehicle device of the present invention includes: a program storage unit that stores a program; an activation processing unit that activates the program; and an update processing unit that receives an update program and an update reason of the program and updates the program with the update program. In a case where update of the program has failed, the activation processing unit activates the program in an activation mode corresponding to the update reason.

### Advantageous Effects of Invention

According to the present invention, it is possible to minimize the likelihood of the vehicle becoming in the inoperable state even in the event of a program update failure.

Problems, configurations, and effects other than those described above will become apparent from the description of the following embodiments.

### BRIEF DESCRIPTION OF DRAWINGS

FIG. 1 is a diagram illustrating a configuration of a program update system according to a first embodiment.

FIG. 2 is a diagram illustrating an update reason table referred to by an activation mode determination unit illustrated in FIG. 1.

FIG. 3 is a sequence diagram illustrating processing of the program update system illustrated in FIG. 1.

FIG. 4 is a flowchart of function determination processing performed in S116 illustrated in FIG. 3.

FIG. 5 is a diagram illustrating a configuration of a program update system according to a second embodiment.

### DESCRIPTION OF EMBODIMENTS

Hereinafter, embodiments of the present invention will be described with reference to the drawings. Note that configurations denoted by the same reference numerals in the respective embodiments have the same functions in the respective embodiments unless otherwise specified, and the description thereof will be omitted.

### First Embodiment

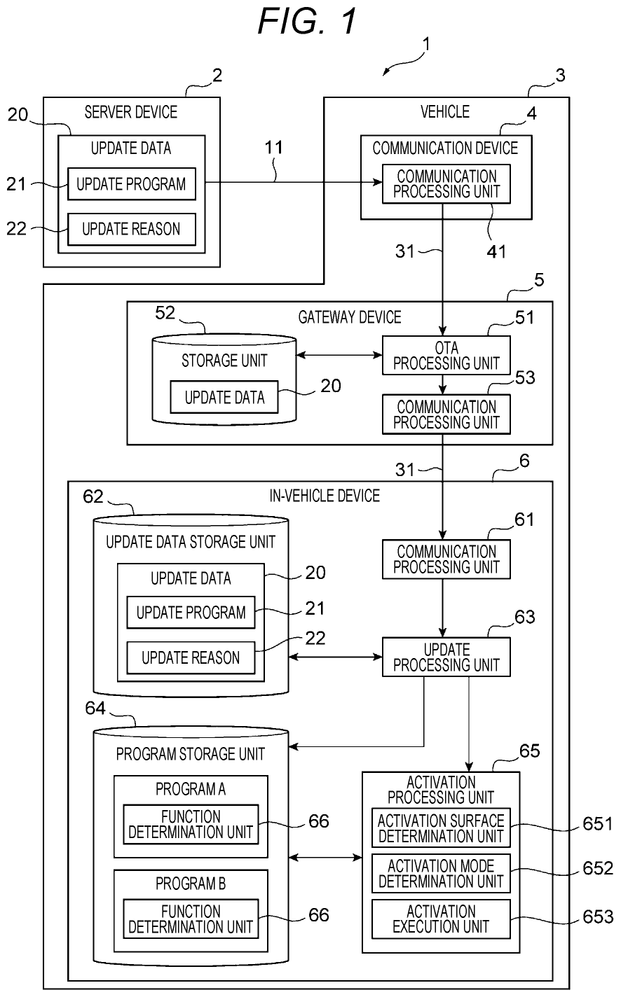

A program update system 1 according to a first embodiment will be described with reference to FIGS. 1 to 4.

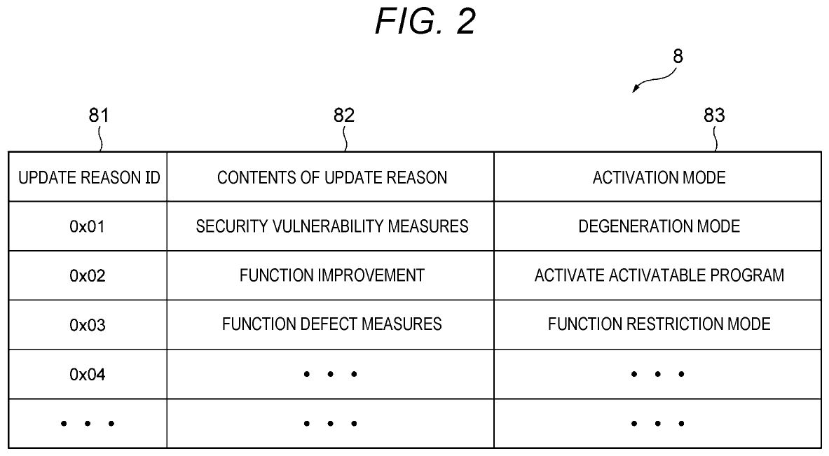

FIG. 1 is a diagram illustrating a configuration of the program update system 1 according to the first embodiment. FIG. 2 is a diagram illustrating an update reason table 8 referred to by an activation mode determination unit 652 illustrated in FIG. 1.

An example will be described in which in a case where the update of a program implemented in an in-vehicle device 6 fails due to some cause and a storage surface (hereinafter also referred to as “activation surface”) of a program storage unit 64 storing the program which is activatable cannot be determined, the program update system 1 of the present embodiment determines an activation mode of the program in the in-vehicle device 6 by using update data 20 acquired from a server device 2. However, the technical idea of the present invention is not limited to this example. For example, the program update system 1 may acquire the update data 20 not from the server device 2 but by another method.

The program update system 1 includes a vehicle 3 on which the in-vehicle device 6 is mounted and the server device 2.

The server device 2 is connected to the vehicle 3 via a wireless communication network 11. The communication scheme of the wireless communication network 11 is typically a communication scheme used for OTA, but may be another communication scheme. The server device 2 always stores the latest update data 20. The server device 2 transmits the update data 20 to the vehicle 3. At this time, the server device 2 issues an update notification (hereinafter, also referred to as “program update notification”) for notifying that the program stored in the program storage unit 64 is updated by the update data 20, and transmits the update notification to the vehicle 3.

The update data 20 includes an update program 21 for updating the program stored in the program storage unit 64 and an update reason 22 which is a reason for updating the program with the update program 21.

The vehicle 3 includes a communication device 4, a gateway device 5, and the in-vehicle device 6. The communication device 4 and the gateway device 5 are connected by a communication bus 31, and the gateway device 5 and the in-vehicle device 6 are connected by the communication bus 31. The communication bus 31 physically includes a plurality of the communication buses 31. The standards of the plurality of communication buses 31 may be the same as or different from each other. The standard of the communication bus 31 is, for example, CAN (registered trademark), LIN (registered trademark), FlexRay (registered trademark), Ethernet (registered trademark), or the like.

The communication device 4 includes a communication processing unit 41. The communication processing unit 41 has a communication interface function for the server device 2 and the gateway device 5. The communication processing unit 41 receives the update data 20 transmitted from the server device 2 and transmits the update data to the gateway device 5.

The gateway device 5 includes an OTA processing unit 51, a storage unit 52, and a communication processing unit 53. The gateway device 5 includes a CPU, a ROM, a RAM, and the like. The gateway device 5 realizes the functions of the OTA processing unit 51 and the communication processing unit 53 by causing the CPU to develop, in the RAM, the programs describing the OTA processing unit 51 and the communication processing unit 53 stored in the ROM and execute the programs.

When receiving the program update notification transmitted from the server device 2 via the communication device 4, the OTA processing unit 51 issues a transmission request of the update data 20 and transmits the transmission request to the server device 2 via the communication device 4. When the update data 20 transmitted from the server device 2 is received via the communication device 4, the OTA processing unit 51 stores the received update data 20 in the storage unit 52. The storage unit 52 includes a nonvolatile storage device, and stores the update data 20. The communication processing unit 53 has a communication interface function for the in-vehicle device 6. The OTA processing unit 51 transmits the update data 20 stored in the storage unit 52 to the in-vehicle device 6 via the communication processing unit 53. At this time, the OTA processing unit 51 issues an update request (hereinafter, also referred to as “program update request”) for requesting to update the program stored in the program storage unit 64 with the update data 20, and transmits, to the in-vehicle device 6, the update request with the update data 20 added. A method of transmitting the program update request and the update data 20 to the in-vehicle device 6 is not particularly limited. Note that the OTA processing unit 51 may transmit the received update data 20 as it is to the in-vehicle device 6 via the communication processing unit 53 without storing the update data in the storage unit 52.

The in-vehicle device 6 includes a communication processing unit 61, an update data storage unit 62, an update processing unit 63, a program storage unit 64, and an activation processing unit 65. The in-vehicle device 6 includes a CPU, a ROM, a RAM, and the like. The in-vehicle device 6 realizes the functions of the communication processing unit 61, the update processing unit 63, a program A, a program B, a function determination unit 66, and the activation processing unit 65 by causing the CPU to develop, in the RAM, the programs describing the communication processing unit 61, the update processing unit 63, the program A, the program B, the function determination unit 66, and the activation processing unit 65 stored in the ROM and execute the programs. The in-vehicle device 6 may be an ECU which controls the vehicle 3.

The update processing unit 63 receives, via the communication processing unit 61, the program update request transmitted from the gateway device 5 and the update data 20 added to the update request. The communication processing unit 61 has a communication interface function for the gateway device 5. The update processing unit 63 stores the received update data 20 in the update data storage unit 62. The update data storage unit 62 includes a nonvolatile storage device, and stores the update data 20.

The update processing unit 63 updates (rewrites) the program stored in the program storage unit 64 with the update data 20 stored in the update data storage unit 62. For example, in a case where the program update request transmitted from the gateway device 5 is the update request of the program A, the update processing unit 63 acquires the update program 21 included in the update data 20 stored in the update data storage unit 62. The update processing unit 63 updates the program A stored in the program storage unit 64 by the acquired update program 21. The update processing unit 63 can check the update status of the program stored in the program storage unit 64 and determine that the update of the program has failed in a case where an event such as battery power supply interruption has occurred before the update of the program is completed. Note that the update processing unit 63 may use the received update data 20 for updating the program stored in the program storage unit 64 as it is without storing the update data in the update data storage unit 62. An update method of the program is not limited to this example.

The program storage unit 64 includes a nonvolatile storage device and stores a program. The program storage unit 64 has a plurality of storage surfaces (ROM) which respectively store the program A and the program B. The program A and the program B may each include a control program for controlling the vehicle and a boot program.

The activation processing unit 65 activates the program (program A or program B) stored in the program storage unit 64. As a result, the activation processing unit 65 activates the in-vehicle device 6. The activation processing unit 65 includes an activation surface determination unit 651, the activation mode determination unit 652, and an activation execution unit 653.

The activation surface determination unit 651 determines whether or not the activation surface is determinable from among a plurality of storage surfaces included in the program storage unit 64. That is, the activation surface determination unit 651 determines whether or not the program stored in any of the plurality of storage surfaces included in the program storage unit 64 can be normally activated. In the in-vehicle device 6, in a case where the update of the program stored in the program storage unit 64 has failed due to an event such as battery power supply interruption, the activation surface determination information set in advance in the program storage unit 64 or the activation processing unit 65 may be lost. The activation surface determination unit 651 can determine whether or not the activation surface is determinable by determining whether or not the activation surface determination information is lost. In a case where the activation surface is determinable, the activation surface determination unit 651 notifies the activation execution unit 653 of information on the determinable activation surface in order to activate the program stored in the determinable activation surface. In a case where the activation surface is indeterminable, the activation surface determination unit 651 can determine that the update of the program stored in the program storage unit 64 has failed. In a case where the activation surface is indeterminable, the activation surface determination unit 651 notifies the activation mode determination unit 652 that the activation surface is indeterminable, in order to determine the activation mode of the program.

The activation mode determination unit 652 determines the activation mode of the program stored in the program storage unit 64. The activation mode is a method of activating the program stored in the program storage unit 64. In a case where the update of the program stored in the program storage unit 64 has failed, the activation mode determination unit 652 determines the activation mode of the program according to the update reason 22. Specifically, in a case where the update of the program has failed and the activation surface determination unit 651 cannot determine the activation surface, the activation mode determination unit 652 reads the update reason 22 from the update data 20 stored in the update data storage unit 62. At this time, the activation mode determination unit 652 may read the update reason 22 via the update processing unit 63, or may read the update reason 22 without via the update processing unit 63.

The activation mode determination unit 652 refers to a predetermined update reason table 8, specifies the activation mode corresponding to the read update reason 22, and notifies the activation execution unit 653 of the specified activation mode. As illustrated in FIG. 2, in the update reason table 8, an update reason ID 81 which is identification information of the update reason 22, contents 82 of the update reason 22, and an activation mode 83 corresponding to the update reason 22 are associated with each other. The activation mode 83 defines how to activate a program and includes setting contents of the activation mode.

The update reason table 8 can be arbitrarily created by the configuration of the program update system 1. The update reason table 8 may be set in advance in the in-vehicle device 6 including the activation mode determination unit 652 or may be included in the update data 20. In addition, in a case where the update reason 22 is destroyed due to some cause and becomes unreadable, the activation mode determination unit 652 may determine to activate the program stored in the program storage unit 64 in a degeneration mode and notify the activation execution unit 653 of the determination.

In a case where the activation surface determination unit 651 can determine the activation surface even when the update of the program stored in the program storage unit 64 fails, the activation execution unit 653 activates the program stored in the determinable activation surface. The activation mode at this time is a normal activation mode adopted at the time of normal activation before updating the program. On the other hand, in a case where the update of the program fails and the activation surface determination unit 651 cannot determine the activation surface, the activation execution unit 653 activates the program in the activation mode notified by the activation mode determination unit 652.

As described above, in a case where the update of the program stored in the program storage unit 64 has failed, the activation processing unit 65 activates the program in the activation mode corresponding to the update reason 22 included in the received update data 20. As a result, the in-vehicle device 6 can avoid a situation in which the program is always activated in the degeneration mode even though the update reason 22 is not a reason having a relatively high risk. For example, in a case where the update reason 22 is to take measures against a defect of a partial function of the program, the in-vehicle device 6 can activate the program in a function restriction mode as illustrated in FIG. 2. Therefore, the in-vehicle device 6 can minimize a likelihood of the vehicle 3 becoming in an inoperable state even in an event of a program update failure.

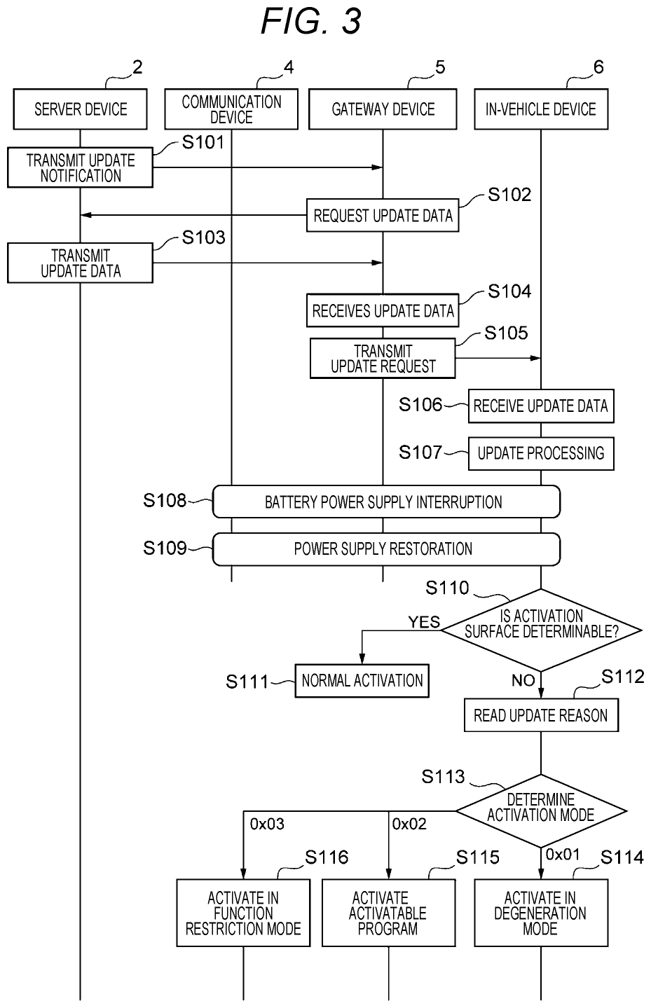

FIG. 3 is a sequence diagram illustrating processing of the program update system 1 illustrated in FIG. 1.

In S101, in a case where there is the update of the program stored in the program storage unit 64, the server device 2 issues a program update notification and transmits the update notification to the gateway device 5 via the communication device 4.

In S102, when receiving the program update notification, the gateway device 5 issues a transmission request for the update data 20 and transmits the transmission request to the server device 2 via the communication device 4.

In S103, when receiving the transmission request of the update data 20, the server device 2 transmits the update data 20 to the gateway device 5 via the communication device 4.

In S104, the gateway device 5 receives the update data 20 via the communication device 4.

In S105, the gateway device 5 issues a program update request, and transmits, to the in-vehicle device 6, the update request with the update data 20 added.

In S106, the in-vehicle device 6 receives the program update request and the update data 20.

In S107, the in-vehicle device 6 performs update processing of updating the program stored in the program storage unit 64 with the update program 21 included in the update data 20.

In S108, it is assumed that the battery power supply interruption occurs during the update processing of the in-vehicle device 6, and the update of the program stored in the program storage unit 64 has failed. When the battery power supply interruption occurs, any activation surface determination information may be lost.

In S109, it is assumed that the power supply of the battery of the vehicle 3 is restored.

In S110, the in-vehicle device 6 determines whether or not the activation surface of the program storage unit 64 is determinable. In a case where the activation surface of the program storage unit 64 is determinable, the in-vehicle device 6 advances the process to S111. In a case where the activation surface of the program storage unit 64 is indeterminable, the in-vehicle device 6 advances the process to S112.

In S111, the in-vehicle device 6 activates the program stored in the program storage unit 64 in the normal activation mode.

In S112, the in-vehicle device 6 reads the update reason 22 included in the update data 20.

In S113, the in-vehicle device 6 determines the activation mode on the basis of the read update reason 22 and the update reason table 8 illustrated in FIG. 2. In a case where the update reason ID 81 of the read update reason 22 is “0x01”, the in-vehicle device 6 advances the process to S114. In a case where the update reason ID 81 of the read update reason 22 is “0x02”, the in-vehicle device 6 advances the process to S115. In a case where the update reason ID 81 of the read update reason 22 is “0x03”, the in-vehicle device advances the process to S116. In a case where the update reason ID 81 of the read update reason 22 is at least “0x02”, the in-vehicle device 6 may notify the user that the update of the program has failed. A method of notifying the user is not particularly limited.

In S114, the in-vehicle device 6 activates the program stored in the program storage unit 64 in the degeneration mode. In a case where the update reason 22 read in S112 is to take measures against the security vulnerability of the program stored in the program storage unit 64, activating the program increases a risk of receiving an attack using a security hole, for example. In this regard, in this case, the in-vehicle device 6 (activation processing unit 65) activates the program in the degeneration mode of performing only the update of the program. As a result, the in-vehicle device 6 can reduce the risk of the attack using the security vulnerability.

In S115, the in-vehicle device 6 activates an activatable program stored in any of the plurality of storage surfaces of the program storage unit 64. In a case where the update reason 22 read in S112 is to improve the function of the program stored in the program storage unit 64, the program stored in any of the plurality of storage surfaces of the program storage unit 64 can be normally activated even when the update of the program fails. In this regard, in this case, the in-vehicle device 6 (activation processing unit 65) activates the activatable program stored in any of the plurality of storage surfaces of the program storage unit 64. As a result, the in-vehicle device 6 can avoid the degeneration mode, in which the vehicle 3 easily falls into the inoperable state, even when the update of the program fails, and can control the vehicle 3 to perform the vehicle evacuation travel, for example. Therefore, the in-vehicle device 6 can minimize a likelihood of the vehicle 3 becoming in an inoperable state even in an event of a program update failure.

In S116, the in-vehicle device 6 performs activation in the function restriction mode. In a case where the update reason 22 read in S112 is to take measures against a defect of a partial function of the program stored in the program storage unit 64, there is a high possibility that the vehicle 3 does not fall into the inoperable state unless the partial function having the defect is executed. In this regard, in this case, the in-vehicle device 6 (activation processing unit 65) activates the program in the function restriction mode in which the partial function having the defect is restricted to be inexecutable. As a result, the in-vehicle device 6 can avoid the degeneration mode, in which the vehicle 3 easily falls into the inoperable state, even when the update of the program fails, and can control the vehicle 3 to perform the vehicle evacuation travel, for example. Therefore, the in-vehicle device 6 can minimize a likelihood of the vehicle 3 becoming in an inoperable state even in an event of a program update failure.

When activating the program stored in the program storage unit 64 in the function restriction mode, the in-vehicle device 6 restricts the function having the defect by performing function determination processing of determining whether or not each function of the program is executable. The in-vehicle device 6 includes the function determination unit 66 that performs function determination processing. The function determination unit 66 determines whether or not each component defining each function of the program is executable. A condition for the function determination unit 66 to determine whether or not execution can be performed may be determined in advance for each component. As illustrated in FIG. 1, the function determination unit 66 may be incorporated in each program stored in the program storage unit 64. Alternatively, the function determination unit 66 may be incorporated in the activation execution unit 653 or the activation processing unit 65.

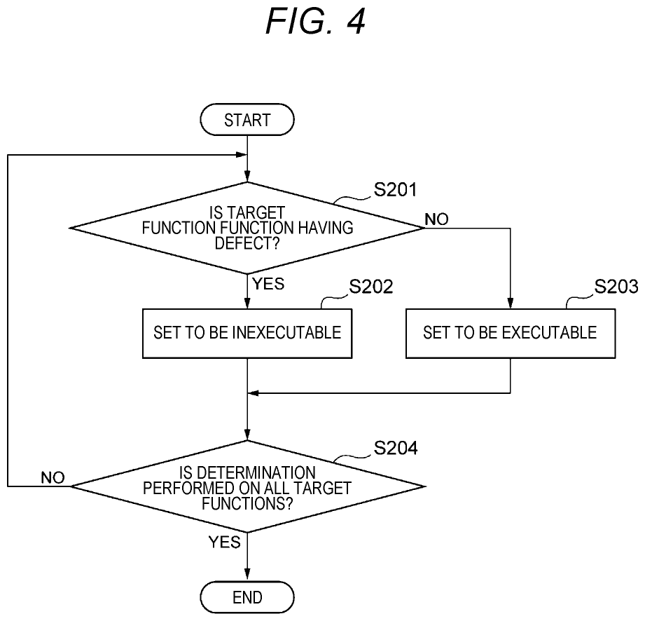

FIG. 4 is a flowchart of the function determination processing performed in S116 illustrated in FIG. 3.

In S201, the in-vehicle device 6 determines whether or not a function to be determined whether or not the function is executable (hereinafter also referred to as a “target function”) among a plurality of functions configuring the program stored in the program storage unit 64 is a function having a defect. In a case where the target function is a function having a defect, the in-vehicle device 6 advances the process to S202. In a case where the target function is not a function having a defect, the in-vehicle device 6 advances the process to S203.

In S202, the in-vehicle device 6 sets the target function to be inexecutable, and the process advances the process to S204.

In S203, the in-vehicle device 6 sets the target function to be executable, and the process advances the process to S204.

In S204, the in-vehicle device 6 determines whether or not the determination on whether or not the execution is possible has been performed on all target functions. In a case where the determination on whether or not the execution is possible has not been performed on all the target functions, the in-vehicle device 6 advances the process to S201. In a case where the determination on whether or not the execution is possible has been performed on all the target functions, the in-vehicle device 6 ends the present processing illustrated in FIG. 4.

As a result, with a relatively simple method, the in-vehicle device 6 can normally execute a function having no defect while restricting a partial function having a defect to inexecutable. Therefore, since the in-vehicle device 6 can easily avoid the degeneration mode, it is possible to easily reduce the likelihood of the vehicle 3 becoming in the inoperable state even in the event of the program update failure.

Note that the update reason table 8 illustrated in FIG. 2 is created by collecting, in one update reason ID 81 “0x03”, the update reason 22 to take measures against a defect of a partial function of the program, but the present invention is not limited thereto. The update reason table 8 may be created by subdividing the update reason 22 to take measures against a defect of a partial function of the program for each function of the program and associating the update reason ID 81 and the activation mode 83 with each function.

### Second Embodiment

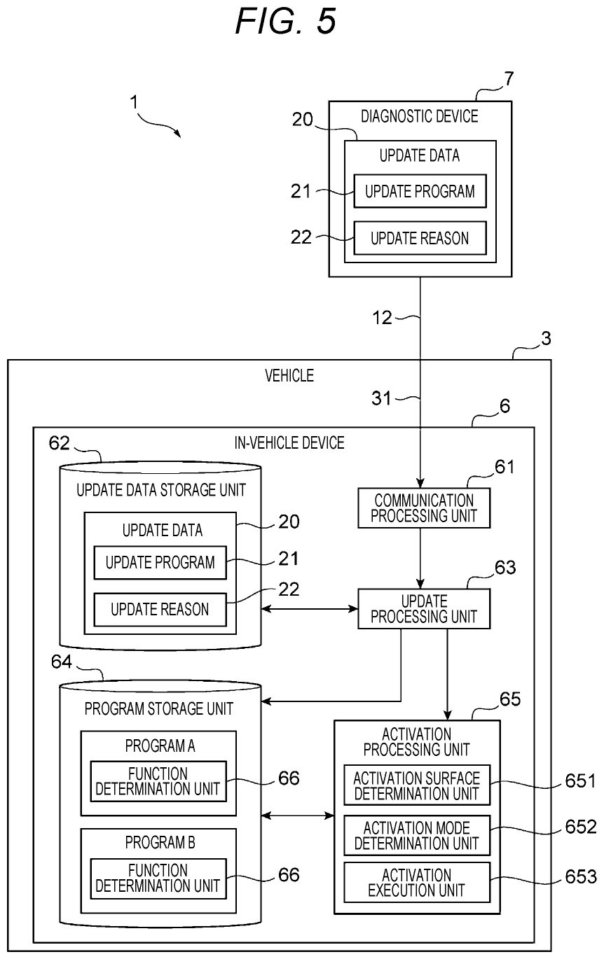

A program update system 1 according to a second embodiment will be described with reference to FIG. 5. In the program update system 1 of the second embodiment, the description of the same configuration and operation as those of the first embodiment will be omitted.

FIG. 5 is a diagram illustrating the configuration of the program update system 1 according to the second embodiment.

In the program update system 1 of the second embodiment, the vehicle 3 is not connected to the server device 2 via the wireless communication network 11, but is connected to a diagnostic device 7 via a cable 12. The diagnostic device 7 stores the update data 20. The diagnostic device 7 transmits the update data 20 to the vehicle 3 via the cable 12.

Similarly to the first embodiment, in a case where the update of the program stored in the program storage unit 64 has failed, the in-vehicle device 6 of the second embodiment activates the program in the activation mode corresponding to the update reason 22 included in the received update data 20. As a result, similarly to the first embodiment, the in-vehicle device 6 of the second embodiment can avoid a situation in which the program is always activated in the degeneration mode even though the update reason 22 is not a reason having a relatively high risk. Therefore, similarly to the first embodiment, the in-vehicle device 6 of the second embodiment can minimize the likelihood of the vehicle 3 becoming in the inoperable state even in the event of the program update failure.

### Others

Note that the present invention is not limited to the above-described embodiments, and various modifications are included. For example, the above-described embodiment has been described in detail for easy understanding of the invention and is not necessarily limited to those having all the described configurations. In addition, a part of the configuration of a certain embodiment can be replaced with the configuration of another embodiment, and the configuration of another embodiment can be added to the configuration of a certain embodiment. Further, it is possible to add, delete, and replace other configurations for a part of the configuration of each embodiment.

Each of the above-described configurations, functions, processing units, processing means, and the like may be realized by hardware by designing a part or all of them with, for example, an integrated circuit. In addition, each of the above-described configurations, functions, and the like may be realized by software by a processor interpreting and executing a program for realizing each function. Information such as a program, a tape, and a file for realizing each function can be stored in a memory, a recording device such as a hard disk and a solid state drive (SSD), or a recording medium such as an IC card, an SD card, or a DVD.

Further, control lines and information lines are described in consideration of necessity for the description, and all control lines and information lines in the product are not necessarily described. It may be considered that almost all the components are connected to each other in actual.

### REFERENCE SIGNS LIST

1 program update system
11 wireless communication network
2 server device
21 update program
22 update reason
3 vehicle
6 in-vehicle device
63 update processing unit
64 program storage unit
65 activation processing unit

1. An in-vehicle device comprising:
a program storage unit that stores a program;
an activation processing unit that activates the program; and
an update processing unit that receives an update program and an update reason of the program and updates the program with the update program, wherein
in a case where update of the program has failed, the activation processing unit activates the program in an activation mode corresponding to the update reason.

2. The in-vehicle device according to claim 1, wherein
in a case where the update reason is to take measures against security vulnerability of the program, the activation processing unit activates the program in a degeneration mode of performing only the update of the program.

3. The in-vehicle device according to claim 1, wherein
in a case where the update reason is to take measures against a defect of a partial function of the program, the activation processing unit activates the program in a function restriction mode of restricting the partial function having the defect to be inexecutable.

4. The in-vehicle device according to claim 1, wherein
the program storage unit includes a plurality of storage surfaces that store the program, and
in a case where the update reason is to improve a function of the program, the activation processing unit activates the program which is stored in any of the plurality of storage surfaces and is activatable.

5. A program update system comprising:
a vehicle on which the in-vehicle device according to claim 1 is mounted; and
a server device that is connected to the vehicle via a wireless communication network and transmits the update program and the update reason to the vehicle.
